(19) United States
(12) Patent Application Publication
(10) Pub. No.: US 2025/0244699 A1
(43) Pub. Date: Jul. 31, 2025

(54) FIXING DEVICE AND IMAGE FORMING APPARATUS

(71) Applicant: KYOCERA Document Solutions Inc., Osaka (JP)

(72) Inventors: Hiroki KAWASAKI, Osaka (JP); Ryohei TOKUNAGA, Osaka (JP); Akihiro KONDO, Osaka (JP); Rina KIKUGAWA, Osaka (JP); Yuta KITABAYASHI, Osaka (JP); Shunsaku FUJII, Osaka (JP); Yuto MASAOKA, Osaka (JP)

(73) Assignee: KYOCERA Document Solutions Inc., Osaka (JP)

(21) Appl. No.: 19/037,044

(22) Filed: Jan. 24, 2025

(30) Foreign Application Priority Data
Jan. 30, 2024 (JP) 2024-012132

(51) Int. Cl. G03G 15/20

(52) U.S. Cl. CPC G03G 15/2017; G03G 15/2064

(57) ABSTRACT

A fixing device includes a fixing belt, a heater, a heat equalizing member, a holding member, and a pressure roller. The heater has a belt contact surface coming into contact with an inner circumferential surface of the fixing belt. The heat equalizing member has a front contact surface coming into contact with a surface opposite to the belt contact surface of the heater and a rear contact surface. The holding member has a storage recess in which the heater and the heat equalizing member are stored. The presser member is pressed against the heater via the fixing belt to form a pressurized region. The storage recess has a heat equalizing member storage part, and a void part having a cross-sectional area narrower than that of the heat equalizing member storage part. The rear contact surface of the heat equalizing member comes into contact with a step surface formed between the heat equalizing member storage part and the void part.

### INCORPORATION BY REFERENCE

This application is based on and claims the benefit of priority from Japanese patent application No. 2024-012132 filed on Jan. 30, 2024 which is incorporated by reference in its entirety.

### BACKGROUND

The present disclosure relates to a fixing device which fixes a toner image on a sheet and an image forming apparatus including the fixing device.

The fixing device of the sliding type is provided with an endless fixing belt heated by a heater and a pressure roller in contact with the fixing belt to form a pressurized region, and the fixing belt and the pressure roller are rotated to fix a toner image on a sheet conveyed to the pressurized region. In such a fixing device, for example, it is necessary to make a temperature distribution of the fixing belt uniform in the width direction of the sheet in order to eliminate a fixing unevenness between a non-sheet passing area and a sheet passing area.

The fixing device may include a heat conductive member in contact with a surface of the heater, which is an opposite surface to a surface in contact with a film (corresponding to the fixing belt). The heat conductive member is held between the heater and a heater holder so as to be in contact with a heat generating region of the heater. By providing such a heat conductive member, a transfer of heat from the non-sheet passing area to the sheet passing area is promoted, and the temperature distribution of the film can be made uniform.

However, in the fixing device described above, since the heat conductive member is also in contact with the heater holder, the heat is transferred from the heat conductive member to the heater holder, and the thermal efficiency of the heater may be lowered.

### SUMMARY

A fixing device according to the present disclosure includes a fixing belt, a heater, a heat equalizing member, a holding member, and a pressure roller. The fixing belt is endless and rotatable. The heater has a belt contact surface coming into contact with an inner circumferential surface of the fixing belt. The heat equalizing member has a front contact surface coming into contact with a surface opposite to the belt contact surface of the heater and a rear contact surface opposite to the front contact surface. The holding member has a storage recess in which the heater and the heat equalizing member are stored. The presser member is pressed against the heater via the fixing belt to form a pressurized region between the pressing member and the fixing belt. A sheet on which a toner image is transferred is heated and pressed at the pressurized region. The storage recess has a heat equalizing member storage part in which the heat equalizing member is stored, and a void part having a cross-sectional area narrower than that of the heat equalizing member storage part, in order in a depth direction of the recess. The rear contact surface of the heat equalizing member comes into contact with a step surface formed between the heat equalizing member storage part and the void part.

An image forming apparatus according to the present disclosure includes an image forming part which forms a toner image on a sheet, and the fixing device which fixes the toner image on the sheet.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a side view schematically showing an internal structure of an image forming apparatus according to one embodiment of the present disclosure.

FIG. 2 is a cross-sectional view schematically showing an internal structure of a fixing device according to the embodiment of the present disclosure.

FIG. 3 is a plan view showing a heater of the fixing device according to the embodiment of the present disclosure.

FIG. 4A is a cross-sectional view showing a holding member of the fixing device according to the embodiment of the present disclosure.

FIG. 4B is a plan view showing the holding member of the fixing device according to the embodiment of the present disclosure.

### DETAILED DESCRIPTION

Hereinafter, with reference to the attached drawings, an image forming apparatus and a fixing apparatus according to the present disclosure will be described.

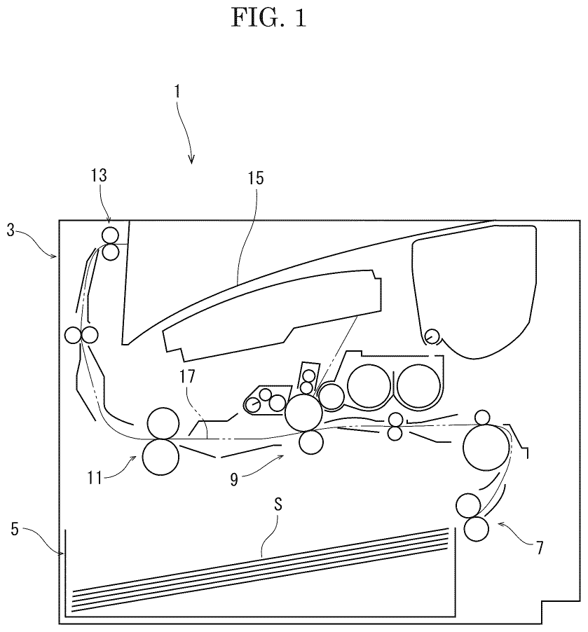

First, the entire structure of the image forming apparatus 1 will be described with reference to FIG. 1. FIG. 1 is a front view schematically showing the internal structure of the image forming apparatus 1. Hereinafter, the right side of the sheet on which FIG. 1 is drawn is defined as the front side of the image forming apparatus 1.

An apparatus main body 3 of the image forming apparatus 1 is provided with a sheet feeding cassette 5 in which sheets S are stored, a sheet feeding device 7 which feeds the sheet S from the sheet feeding cassette 5, an image forming part 9 which forms a toner image on the sheet S by the electrophotographic method, a fixing device 11 which fixes the toner image on the sheet S, a sheet discharge device 13 which discharges the sheet S, and a sheet discharge tray 15 on which the discharged paper S is stacked. Further, the apparatus main body 3 is formed with a conveyance path 17 along which the sheet S is conveyed from the sheet feeding device 7 to the sheet discharge device 13 through the image forming part 9 and the fixing device 11.

The image forming operation will be briefly described. First, the sheet S is fed from the sheet feeding cassette 5 to the conveyance path 17 by the sheet feeding device 7. The fed sheet S is conveyed to the image forming part 9 along the conveyance path 17, and a toner image is formed on the sheet S by the electrophotographic method in the image forming part 9. The sheet S on which the toner image is formed is conveyed to the fixing device 11 along the conveyance path 17. The fixing device 11 fixes the toner image on the sheet S. The sheet S on which the toner image is fixed is conveyed to the sheet discharge device 13 along the conveyance path 17. The sheet discharge device 13 discharges the sheet S to the sheet discharge tray 15.

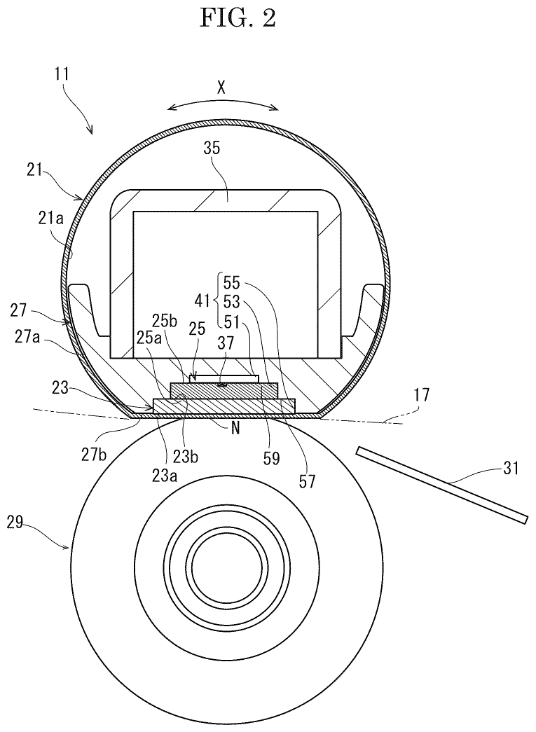

Next, the fixing device 11 will be described with reference to FIG. 2. FIG. 2 is a cross-sectional view schematically showing the internal structure of the fixing device 11.

The fixing device 11 includes a fixing belt 21, a heater 23 which heats the fixing belt 21, a heat equalizing member 25 in contact with the heater 23, a holding member 27 which holds the heater 23 and the heat equalizing member 25, a pressure roller 29 as a pressure member which forms a pressurized region N between the fixing belt 21 and the pressure roller 29, and a conveyance guide 31.

First, the fixing belt 21 will be described. The fixing belt 21 is an endless belt, and has a predetermined inner diameter and a width longer than a width of a sheet passing area (for example, a width of a A4-size sheet). The fixing belt 21 is made of flexible material, and has a base layer, an elastic layer provided on the outer circumferential surface of the base layer, and a release layer provided on the outer circumferential surface of the elastic layer. The base layer is made of metal such as SUS or Ni. The elastic layer is formed of silicon rubber or the like. The release layer is made of PFA tube or the like. In some cases, a sliding layer is formed on the inner circumferential surface of the base layer. The sliding layer is made of polyimide amide, PTFE or the like.

Both ends of the fixing belt 21 are rotatably supported by end holders (not shown). Both the end holders are supported by a fixing housing (not shown). A stay 35 penetrates the inner hollow space of the fixing belt 21. Both ends of the stay 35 are supported by the end holders.

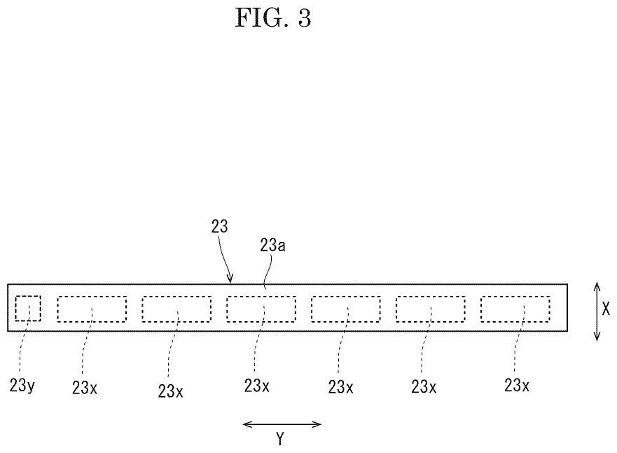

Next, the heater 23 will be described with reference to FIG. 3. FIG. 3 is a plan view showing the heater 23.

The heater 23 is a flat plate member having a width equal to a width of the fixing belt 21, a predetermined length along the circumferential direction X of the fixing belt 21, and a predetermined thickness. The heater 23 has a substrate made of stainless steel or ceramic, an electric insulating layer made of glass or the like, a resistance heating element layer and a protective layer which are laminated in order from the rear side to the front side. The resistance heating element layer includes a plurality of resistance heating elements 23x and an electrode 23y. The resistance heating elements 23x are arranged in a region corresponding to the sheet passing area of the fixing belt 21 in a row in the width direction Y of the fixing belt 21. The electrode 23y is disposed outside the resistance heating elements 23x in the width direction Y. When a power is applied to the resistance heating elements 23x through the electrode 23y, the resistance heating element layer generates heat. The surface of the protective layer is formed flat to form a belt contact surface 23a in contact with the inner circumferential surface 21a of the fixing belt 21.

Next, the heat equalizing member 25 will be described with reference to FIG. 2. The heat equalizing member 25 is a plate-like member having a width narrower than the heater 23, a length shorter than the heater 23, and a predetermined thickness. The heat equalizing member 25 is made of material having high thermal conductivity, such as metal such as aluminum or a graphite sheet. The heat equalizing member 25 has a front side contact surface 25a and a rear side contact surface 35b opposite to the front side contact surface 25a. The front side contact surface comes into contact with a surface opposite to the belt contact surface 23a of the heater 23. The front side contact surface 25a and the rear side contact surface 25b are formed flat. A temperature sensor 37 is attached to the rear side contact surface 25b.

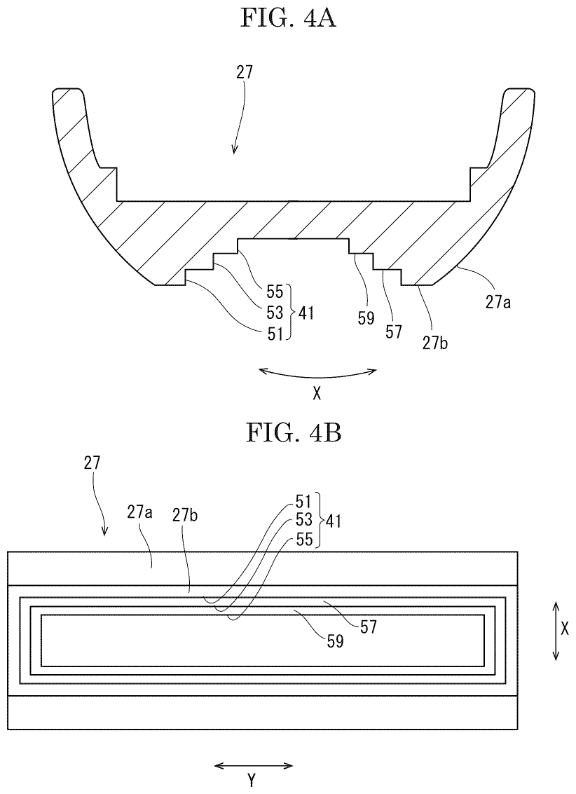

Next, the holding member 27 will be described with reference to FIG. 4A and FIG. 4B. FIG. 4A is a cross-sectional view showing the holding member 27, and FIG. 4B is a plan view showing the holding member 27 viewed from the lower side. The holding member 27 is a substantially semi-cylindrical member having a width equal to a width of the fixing belt 21 and a predetermined length along the circumferential direction X. The holding member 27 is made of, for example, a heat-resistant resin such as liquid crystal polymer.

As shown in FIG. 4A, the outer circumferential surface 27a of the holding member 27 is curved along the inner circumferential surface 21a (see FIG. 2) of the fixing belt 21. The outer circumferential surface of the top portion 27b of the holding member 27 is formed flat. A storage recess 41 in which the heater 23 and the heat equalizing member 25 are stored is formed in the top portion 27b. As shown in FIG. 2, with the center positions of the heat equalizing member 25 and the heater 23 being the same in the width direction Y and the circumferential direction X, the heat equalizing member 25 is stored in the inside of the storage recess 41, and the heater 23 is stored on the front side (outside) of the heat equalizing member 25.

The storage recess 41 is formed in the three-step stair-like shape whose cross-sectional area is gradually narrowed in the depth direction, and has a heater storage part 51 on the front side (outside), a heat equalizing member storage part 53 on the inner side (inside) of the heater storage part 51, and a void part 55 on the inner side of the heat equalizing member storage part 53. As described above, a width and a length of the heater 23 are larger than a width and a length of the heat equalizing member 25, and the heat equalizing member 25 and the heater 23 are arranged such that their center positions in the width direction Y and the circumferential direction X are the same. Therefore, as shown in FIG. 4B, a rectangular frame-shaped outer step surface 57 is formed between the heater storage part 51 and the heat equalizing member storage part portion 53. A width and a length of the void part 55 are smaller than a width and a length of the heat equalizing member 25. Therefore, a rectangular frame-shaped inner step surface 59 is formed between the heat equalizing member storage part 53 and the void part 55.

The heat equalizing member 25 is stored in the heat equalizing member storage part 53. The outer circumference of the rear side contact surface 25b of the heat equalizing member 25 is in contact with the inner step surface 59. As shown in FIG. 2, there is a gap between the central portion of the rear side contact surface 25b and the bottom surface of the void part 55. The heater 23 is stored in the heater storage part 51. The belt contact surface 23a of the heater 23 is flush with the outer circumferential surface of the top portion 27b of the holding member 27. The outer circumference of the surface opposite to the belt contact surface 23a of the heater 23 is in contact with the outer step surface 57. The center portion of the opposite surface is in contact with the front side contact surface 25a of the heat equalizing member 25.

As shown in FIG. 2, the holding member 27 is supported by the stay 35 in the inner hollow space of the fixing belt 21.

Next, the pressure roller 29 will be described with reference to FIG. 2. The pressure roller 29 has a core metal, an elastic layer provided on the outer circumferential surface of the core metal, and a release layer provided on the outer circumferential surface of the elastic layer. The elastic layer is made of silicon rubber or the like. The release layer is made of PFA tube or the like.

The pressure roller 29 is supported so as to be pressed against the heater 23 from below the fixing belt 21. Thus, a pressurized region N is formed between the fixing belt 21 and the pressure roller 29. A width of the pressurized region N is narrower than a width of the heat equalizing member 25, and a length of the pressurized region N is shorter than a length of the heat equalizing member 25. The pressure roller 29 is driven by a motor (not shown) to be rotated in the counterclockwise direction of FIG. 2. When the pressure roller 29 is driven and rotated by the motor, the fixing belt 21 is driven and rotated in the clockwise direction of FIG. 2 opposite to the pressure roller 29. As a result, the sheet S passes through the pressurized region N.

Next, the conveyance guide 31 will be described with reference to FIG. 2. The conveyance guide 31 is disposed on the upstream side of the pressurized region N in the conveyance direction of the sheet S, and guides the sheet S conveyed along the conveyance path 17 to the pressurized region N.

The fixing operation of the fixing device 11 having the above configuration will be described. First, the pressure roller 29 is driven by the motor to be rotated, and the fixing belt 21 follows the pressure roller 29 to be rotated in a direction opposite to the rotational direction of the pressure roller 29 (clockwise direction in FIG. 2). At the same time, a heater 23 is driven to heat the fixing belt 21. The fixing belt 21 is heated to a predetermined control temperature (for example, 160° C.) based on a temperature detected by the temperature sensor 37 attached to the heat equalizing member 25. After the fixing belt 21 is heated in this manner, the sheet S on which the toner image is transferred is guided by the conveyance guide 31 and conveyed to the pressurized region N. When the sheet S passes through the pressurized region N, it is heated by the fixing belt 21 and pressurized by the pressure roller 29 and the fixing belt 21, then the toner image is fixed on the sheet S. The sheet S on which the toner image is fixed is conveyed along the conveyance path 17 from the pressurized region N.

As described above, according to the fixing device 11 of the present disclosure, the heat generated from the resistance heating element layer of the heater 23 is transmitted in the width direction Y through the heat equalizing member 25. Therefore, even when the sheet S having a width smaller than a width of the maximum sheet passing area is conveyed, the heat is transmitted from the non-sheet passing area to the sheet passing area through the heat equalizing member 25. Therefore, a temperature of the heater 23 in the width direction Y can be made uniform, and a temperature of the fixing belt 21 in the width direction Y can be made uniform.

Further, the rear side contact surface 25b of the heat equalizing member 25 is in contact with the rectangular frame-shaped inner step surface 59 of the holding member 27, and there is a gap between the rear side contact surface 25b and the bottom surface of the void part 55. Therefore, a contact area between the heat equalizing member 25 and the holding member 27 can be made as small as possible. Since the heat equalizing member 25 is in contact with the holding member 27, the heat transferred from the heater 23 to the heat equalizing member 25 is also transferred to the holding member 27. In this case, by making the contact area between the heat equalizing member 25 and the holding member 27 as small as possible, the transfer of heat from the heat equalizing member 25 to the holding member 27 can be suppressed as much as possible, and the heat loss of the heater 23 can be reduced.

Since the outside step surface 57 and the inside step surface 59 have a rectangular frame shape, the heater 23 and the heat equalizing member 25 can be stably supported by the storage recess 41.

In the embodiment described above, a width and a length of the heat equalizing member 25 are shorter than a width and a length of the heater 23, but a width and a length of the heat equalizing member 25 may be equal to a width and a length of the heater 23. In this case, the heater storage part 51 and the heat equalizing member storage part 53 of the storage recess 41 of the holding member 27 are formed to have the same size, and the void part 55 is formed to have a narrower cross-sectional area than the heater storage part 51 and the heat equalizing member storage part 53.

Further, since the above-described description of the embodiments of the present disclosure describes the preferred embodiments of the present disclosure, various technically preferable limitations may be added, but the technical scope of the present disclosure is not limited to these embodiments unless the description specifically limits the present disclosure.

1. A fixing device comprising:
a rotatable endless fixing belt;
a heater which has a belt contact surface coming into contact with an inner circumferential surface of the fixing belt;
a heat equalizing member which has a front contact surface coming into contact with a surface opposite to the belt contact surface of the heater and a rear contact surface opposite to the front contact surface;
a holding member which has a storage recess in which the heater and the heat equalizing member are stored; and
a presser member which is pressed against the heater via the fixing belt to form a pressurized region between the pressing member and the fixing belt, a sheet on which a toner image is transferred being heated and pressed at the pressurized region, wherein
the storage recess has a heat equalizing member storage part in which the heat equalizing member is stored, and a void part having a cross-sectional area narrower than that of the heat equalizing member storage part, in order in a depth direction of the recess, and
the rear contact surface of the heat equalizing member comes into contact with a step surface formed between the heat equalizing member storage part and the void part.

2. The fixing device according to claim 1, wherein
the step surface has a rectangular frame-like shape.

3. The fixing device according to claim 1, wherein
the storage recess has a heater storage part in which the heater is stored on a front side of the heat equalizing member storage part in the depth direction, the heater storage part having a cross-sectional area wider than that of the heat equalizing member storage part, and
the surface opposite to the belt contact surface of the heater comes into contact with a rectangular frame shaped step surface formed between the heater storage part and the heat equalizing member storage part.

4. An image forming apparatus comprising:
an image forming part which forms a toner image on a sheet, and
the fixing device according to claim 1, which fixes the toner image on the sheet.
